(19) United States
(12) Patent Application Publication
(10) Pub. No.: US 2026/0216703 A1
(43) Pub. Date: Jul. 30, 2026

(54) NITROGEN-CONTAINING METAL OXIDE PRE-CATALYST FOR THE DIRECT CONVERSION OF CO2 TO FUEL RANGE HYDROCARBONS

(71) Applicants: SAUDI ARABIAN OIL COMPANY, Dhahran (SA); KING ABDULLAH UNIVERSITY OF SCIENCE AND TECHNOLOGY, Thuwal (SA)

(72) Inventors: Jorge Gascon SABATE, Thuwal (SA); Jose Luis Santos MUÑOZ, Thuwal (SA); Jean Marcel Ribeiro GALLO, Thuwal (SA); Dina K. ALSAADI, Thuwal (SA); Arwa Othman ALAHMADI, Thuwal (SA); Mohnnad H. ALABSI, Dhahran (SA)

(73) Assignees: SAUDI ARABIAN OIL COMPANY, Dhahran (SA); KING ABDULLAH UNIVERSITY OF SCIENCE AND TECHNOLOGY, Thuwal (SA)

(21) Appl. No.: 19/040,710

(22) Filed: Jan. 29, 2025

(51) Int. Cl. B01J 23/78; B01J 27/24; B01J 37/03; B01J 37/08; B01J 37/18; C10G 2/00

(52) U.S. Cl. CPC B01J 23/78; B01J 27/24; B01J 37/031; B01J 37/08; B01J 37/18; C10G 2/50; B01J 2523/13; B01J 2523/17; B01J 2523/842

(57) ABSTRACT

A method of making a catalyst comprises dissolving one or more metal salts in water to form a solution, wherein the metal salts comprise one or more of copper, potassium, iron, manganese, cobalt, palladium, silver, lanthanum, vanadium, chromium, gadolinium, gallium, zinc, nickel, or niobium; adding a nitrogen-containing precipitating reagent to the solution until the solution has a pH of about 6.5; separating solids from the solution to obtain the pre-catalyst; calcining the solids at a temperature between 350° C. and 900° C. to obtain calcined solids; and exposing the calcined solids to CO₂ and H₂ under reaction conditions, to form the catalyst. The catalyst can be used in a method to convert CO₂ to hydrocarbons by reacting CO₂ and H₂ at a reaction temperature, a reaction pressure, and a reaction gas hourly space velocity (GHSV); thereby obtaining hydrocarbons.

### FIELD OF THE DISCLOSURE

The present disclosure relates generally to methods for converting CO₂ to hydrocarbons. More specifically, the present disclosure refers to methods to utilize iron and copper-based heterogeneous catalysts doped with potassium for the direct conversion of carbon dioxide into fuel range hydrocarbons.

### BACKGROUND OF THE DISCLOSURE

Cobalt- and/or iron-based catalysts are widely utilized in carbon dioxide hydrogenation by modified (CO₂-based) Fischer-Tropsch processes. However, Fe—K catalyst has a disadvantage of low activity (less than 20% yield of fuel range (C₅₊) hydrocarbons). Though higher activity has been seen with the best-known multi-component catalyst, Fe—Mn—K, this catalyst yields only 23.6% fuel range hydrocarbons. This is only slightly higher than the 22.5% and 19.8% yields reported for Fe/K supported on mesoporous carbon (MPC) and Na/ZnFe₂O₃, respectively.

Additionally, Fe—Mn—K and Fe/K supported on MPC have product selectivity for methane of 10.4% and 9.7%, respectively. Methane is an undesirable byproduct which is difficult to separate from the unreacted CO₂/H₂ stream and accumulates in the recycle stream.

### SUMMARY OF THE DISCLOSURE

Various details of the present disclosure are hereinafter summarized to provide a basic understanding. This summary is not an exhaustive overview of the disclosure and is neither intended to identify certain elements of the disclosure, nor to delineate the scope thereof. Rather, the primary purpose of this summary is to present some concepts of the disclosure in a simplified form prior to the more detailed description that is presented hereinafter.

According to an embodiment consistent with the present disclosure, a method of making a catalyst comprises dissolving one or more metal salts in water to form a solution, wherein the metal salts comprise one or more of copper, potassium, iron, manganese, cobalt, palladium, silver, lanthanum, vanadium, chromium, gadolinium, gallium, zinc, nickel, or niobium; adding a nitrogen-containing precipitating reagent to the solution until the solution has a pH of about 6.5; separating solids from the solution to obtain the pre-catalyst; calcining the solids at a temperature between 350° C. and 900° C. to obtain calcined solids; and exposing the calcined solids to CO₂ and H₂ under reaction conditions, to form the catalyst.

In another embodiment, a pre-catalyst comprises oxides or carbonates of iron; copper; and potassium; wherein the pre-catalyst comprises 25-100 mol % iron, 30-75 mol % copper, 0.1-10 mol % potassium on a metal basis; and nitrogen.

In a further embodiment, a catalyst comprises oxides, carbides, carbonates, and metallic particles of iron; oxides and metallic particles of copper; and potassium; wherein the catalyst comprises 25-100 mol % iron, 30-75 mol % copper, 0.1-10 mol % potassium on a metal basis.

In an additional embodiment, a method to convert CO₂ to hydrocarbons comprises reacting CO₂ and H₂ in the presence of a catalyst comprising oxides, carbides, carbonates, and metallic particles of iron; oxides and metallic particles of copper; and potassium; wherein the catalyst comprises 25-100 mol % iron, 30-75 mol % copper, 0.1-10 mol % potassium on a metal basis, at a reaction temperature, a reaction pressure, and a reaction gas hourly space velocity (GHSV); thereby obtaining hydrocarbons.

Any combinations of the various embodiments and implementations disclosed herein can be used in a further embodiment, consistent with the disclosure. These and other aspects and features can be appreciated from the following description of certain embodiments presented herein in accordance with the disclosure and the accompanying drawings and claims.

### BRIEF DESCRIPTION OF THE DRAWINGS

FIG. 1 is the boiling point distribution curve of liquid collected at different reaction times using Fe₁—K_{0.05} catalysts.

FIG. 2 is the boiling point distribution curve of liquid collected at different reaction times using Fe₁—Cu₂—K_{0.05} catalysts.

FIG. 3 is a graph of yield of different liquid fractions as a function of time of reaction for Fe₁—K_{0.05} catalyst.

FIG. 4 is a graph of yield of different liquid fractions as a function of time of reaction for Fe₁—Cu₂—K_{0.05} catalyst.

FIG. 5 is a graph of CO₂ conversion (%) as a function of reaction time for Fe₁Cu₂K_{0.05} catalyst.

FIG. 6 is a graph of product selectivity as a function of reaction time for Fe₁Cu₂K_{0.05} catalyst.

FIG. 7A-7F are bar graphs of the relative percentage (%) of liquid phase products by carbon number and hydrocarbon family: (A) 0-20 hours for Fe₁—K_{0.05} catalyst; (B) 65-100 hours for Fe₁—K_{0.05} catalyst; (C) 0-20 hours for Fe₁Cu₂—K_{0.05} catalyst; (D) 20-40 hours for Fe₁Cu₂—K_{0.05} catalyst; (E) 40-65 hours for Fe₁Cu₂—K_{0.05} catalyst; (F) 65-100 hours for Fe₁Cu₂—K_{0.05} catalyst.

FIG. 8A-8F are bar graphs of the relative percentage (%) of liquid and gas phase products by carbon number and hydrocarbon family: (A) 0-20 hours for Fe₁—K_{0.05} catalyst; (B) 65-100 hours for Fe₁—K_{0.05} catalyst; (C) 0-20 hours for Fe₁Cu₂—K_{0.05} catalyst; (D) 20-40 hours for Fe₁Cu₂—K_{0.05} catalyst; (E) 40-65 hours for Fe₁Cu₂—K_{0.05} catalyst; (F) 65-100 hours for Fe₁Cu₂—K_{0.05} catalyst.

FIG. 9 is X-Ray Diffraction (XRD) pattern for Fe—K, FeₓCu_{y}—K, and Cu—K calcined pre-catalysts.

FIG. 10 is an XRD pattern (normalized intensity) for the pre-catalyst, calcined pre-catalyst, reduced, and spent forms of Fe₁—K_{0.05} catalyst.

FIG. 11 is a subsection of the XRD pattern of FIG. 10.

FIG. 12 is an XRD pattern (normalized intensity) for the pre-catalyst, calcined pre-catalyst, reduced, and spent forms of Fe₁—Cu₂—K_{0.05} catalyst.

FIG. 13 is a subsection of XRD pattern of FIG. 12.

FIG. 14A is a high-resolution transmission electron microscopy (HR-TEM) image of spent Fe₁Cu₂—K_{0.05} catalyst after 100 hours of reaction.

FIG. 14B is a scanning transmission electron microscopy with a high angle annular dark field scanning (STEM-HAADF) micrograph of spent Fe₁Cu₂—K_{0.05} catalyst after 100 hours of reaction.

FIG. 14C is a STEM-HAADF micrograph of spent Fe₁—K_{0.05} catalyst after 150 hours of reaction.

FIG. 15A is a STEM-HAADF micrograph of reduced Fe₁Cu₂K_{0.05} catalyst.

FIG. 15B is a STEM-HAADF micrograph of spent Fe₁Cu₂K_{0.05} after 100 hours of reaction.

FIG. 15C is a STEM-HAADF micrograph of spent Fe₁Cu₂K_{0.05} after 400 hours of reaction.

### DETAILED DESCRIPTION

Embodiments of the present disclosure will now be described in detail with reference to the accompanying Figures. Like elements in the various figures may be denoted by like reference numerals for consistency. Further, in the following detailed description of embodiments of the present disclosure, numerous specific details are set forth in order to provide a more thorough understanding of the claimed subject matter. However, it will be apparent to one of ordinary skill in the art that the embodiments disclosed herein may be practiced without these specific details. In other instances, well-known features have not been described in detail to avoid unnecessarily complicating the description. Additionally, it will be apparent to one of ordinary skill in the art that the scale of the elements presented in the accompanying Figures may vary without departing from the scope of the present disclosure.

Unless otherwise indicated, all numbers indicating quantities in this disclosure are to be understood as being modified by the term “about” in all instances. It should also be understood that the precise numerical values used in the specification and claims constitute specific embodiments.

The term “and/or” as used in a phrase such as “A and/or B” herein is intended to include “A and B,” “A or B,” “A,” and “B.”

Ranges referred to as “between” minimum and maximum values are inclusive of the minimum and maximum values.

As used herein, “wt %” means percentage by weight, “vol %” means percentage by volume, “mol %” means percentage by mole, “ppm” means parts per million, and “ppm wt” and “wppm” are used interchangeably and mean parts per million on a weight basis. All concentrations herein, unless otherwise stated, are expressed on the basis of the total amount of the composition in question.

For the purposes of this disclosure, the nomenclature of elements is pursuant to the NEW NOTATION version of the Periodic Table of Elements as provided in Hawley's Condensed Chemical Dictionary, 16th Ed., John Wiley & Sons, Inc., (2016), Appendix V unless otherwise noted.

As used herein, the terms “optional” or “optionally” mean that the subsequently described event or circumstance does or does not occur (or an element is or is not present) and that the description includes instances where said event or circumstance occurs and instances where said event or circumstance does not occur.

The reactor described in various embodiments may be of the fixed-bed continuous flow type, or any other reactor commonly used in the field. In certain embodiments, it may be beneficial to operate the reactor at a pressure of 20 bar or higher and a temperature of at least 300° C. However, it should be understood by those with expertise in the art that the reactor can be operated at any temperature and pressure appropriate for carrying out the modified CO₂ Fischer-Tropsch reaction.

There is an ongoing need to maximize the yield of C₅₊ hydrocarbons to make carbon dioxide hydrogenation into liquid fuels cost-effective. To address this goal, the development of new catalysts can maintain or improve the stability of the catalyst, increase the yield of C₅₊ hydrocarbons, and/or decrease the yield of methane. The methods of catalyst production and the catalysts of this disclosure can produce C₅₊ hydrocarbons in yields of 30 mole percent and greater on a carbon-carbon basis, produce less methane, and remain stable for approximately 400 hours, as will be demonstrated in the examples.

### Pre-Catalysts and Formation Thereof

In some aspects, this disclosure relates to pre-catalysts and methods of making the pre-catalysts. The pre-catalysts can comprise metal oxides, metal carbonates, and nitrogen. The metal species in the oxides and carbonates can be iron, copper, or both. The nitrogen can be present in one or more nitrogen-containing species. The pre-catalysts can also further comprise potassium, e.g. as potassium carbonate. The pre-catalysts can also further comprise at least one metal that promotes CO₂-based Fischer-Tropsch processes, such as manganese, cobalt, palladium, silver, lanthanum, vanadium, chromium, gadolinium, gallium, zinc, nickel, niobium, or any combinations thereof.

In some embodiments, the pre-catalyst comprises iron, copper, and potassium. On a metal basis, the catalyst composition may comprise 25-100 mol % iron, 30-75 mol % copper, 0.1-10 mol % potassium, and 0-60 mol % metal promoter. In various embodiments, the molar ratio Fe/Cu/K is 1/2/0.05, indicating 32.8 mol % of Fe, 65.6 mol % of Cu, and 1.6 mol % of K.

The pre-catalyst can comprise iron oxides, iron carbonates, copper oxides, copper carbonates, potassium oxide, potassium carbonate, cationic potassium, and nitrogen species.

The pre-catalyst may be an unsupported catalyst. In other words, the pre-catalyst may be non-incorporated onto or into an aluminum or silica base, or in any other support.

The pre-catalyst may be free of zeolites. In other words, zeolites are not expected to be present, e.g., are below detectable limits, in the pre-catalyst.

The metal promoter may be present at 0-60 mol % or any subrange thereof, such as 0.1-60 mol %, 0.1-50 mol %, 1-50 mol %, or 10-50 mol %. The metal promoter may be selected from the group consisting of manganese, cobalt, palladium, silver, lanthanum, vanadium, chromium, gadolinium, gallium, zinc, nickel, niobium, and combinations thereof.

Among other possible techniques, formation of pre-catalysts may include dissolving one or more metal salts in water to form a solution, wherein the metal salts comprise one or more of iron, copper, potassium, manganese, cobalt, palladium, silver, lanthanum, vanadium, chromium, gadolinium, gallium, zinc, nickel, or niobium. The metal salts may be nitrates, oxides, citrates, lactates, formates, acetates, sulfates, carbonates, chlorides, bromides, EDTA salts, oxalates, benzoates, stearates, and tartrates. A nitrogen-containing precipitating reagent, either alone or in combination with an inorganic base, may be added to the solution until the solution has a pH between 5 and 8.5. The precipitated solid may be separated from the solution.

The nitrogen-containing precipitating reagent may be ammonium carbonate, ammonium lactate, ammonium tartrate, urea, betaine, tetraethylammonium bicarbonate, triethylammonium bicarbonate, choline bicarbonate, or combinations thereof.

The nitrogen-containing precipitating reagent may be a metal-free alkaline salt, such as an alkali metal-free and alkaline earth metal-free salt. Excluding alkali and alkaline earth metals may reduce the need for a washing step or other treatment of the pre-catalyst prior to activation. However, the separated solid pre-catalyst may optionally be washed with an aqueous solution to remove any remaining salt ions.

### Catalysts and Activation Thereof

The pre-catalysts of the disclosure may be activated to form an active catalyst. Activation may comprise calcining the pre-catalyst, at a temperature of 350° C. to 900° C. in either static air or under a flow of oxygen (pure or diluted with 5-95% nitrogen), followed by reduction by exposure to hydrogen or a mixture of hydrogen and an inert gas, such as at 300 to 500° C., followed by exposure of the reduced material to a mixture of hydrogen gas and carbon dioxide under reaction conditions (e.g., H₂/CO₂ ratio, temperature, pressure, and other conditions suitable for CO₂-based Fischer-Tropsch using the catalyst). Alternatively, the reduction step may be omitted, and after calcination, the solid may be exposed to reaction conditions to complete activation.

The catalyst may comprise metal oxides, metal carbides, metal carbonates, and metallic particles. Metal species present in the catalyst will be substantially inherited from the pre-catalyst. For example, the metal species in the oxides and carbides can be iron, copper, or both. The catalysts can also further comprise potassium. The pre-catalysts can also further comprise at least one metal that promotes CO₂-based Fischer-Tropsch processes, such as manganese, cobalt, palladium, silver, lanthanum, vanadium, chromium, gadolinium, gallium, zinc, nickel, niobium, or any combinations thereof. On a metal basis, the catalyst may comprise 25-100 mol % iron, 30-75 mol % copper, 0.1-10 mol % potassium, and 0-60% metal promoters.

Specifically, for a catalyst comprising Fe and Cu, the catalyst may comprise Fe₃O₄, Fe₂O₃ (as hematite, magnetite, or both), Fe₅C₂, elemental Fe, CuO, Cu₂O, CuFe₂O₄, elemental Cu, CuₓC, K₂O, K₂CO₃, K⁺, or any combination thereof. The catalyst may also comprise other species of these metals, as well as various oxides, carbides, carbonates, and elemental species of other metals, such as potassium and metal promoters, if included.

Some embodiments include methods of converting CO₂ to hydrocarbons. The methods may include reacting CO₂ and H₂ in the presence of the catalyst at a reaction temperature, a reaction pressure, and a reaction gas hourly space velocity (GHSV), thereby obtaining hydrocarbons.

The reaction pressure may range from about 1 to about 100 bar. In some embodiments, the reaction pressure ranges from 5 bar to 80 bar, 5 bar to 75 bar, 5 bar to 70 bar, 5 bar to 60 bar, and 5 bar to 50 bar. In various embodiments, the reaction pressure ranges from 10 bar to 60 bar, 15 to 60, 20 to 60, 25 to 60, 10 to 50, 20 to 50, or 30 to 50. In some embodiments, the reaction pressure is about 30 bar. With regards to “about”, as used in reference to the reaction pressure, “about” means plus or minus 3 bar.

The reaction temperature may be from 200° C. to 500° C. In some embodiments, the reaction temperature is from 250° C. to 450° C., 300° C. to 400° C., or about 350° C. With regards to “about”, as used in reference to the reaction temperature, “about” means plus or minus 5° C.

In a continuous reaction, the gas hourly space velocity (GHSV) may be from 1000 mL g⁻¹ h⁻¹ to 100,000 mL g⁻¹ h⁻¹. In some embodiments, the GHSV is from 1500 mL g⁻¹ h⁻¹ to 15,000 mL g⁻¹ h⁻¹, from 2000 mL g⁻¹ h⁻¹ to 10,000 mL g⁻¹ h⁻¹, or from 5000 mL g⁻¹ h⁻¹ to 8000 mL g⁻¹ h⁻¹.

Catalyst stability is a concern in any chemical process. The catalyst produced by activation of the pre-catalyst may be stable for 400 hours under reaction conditions described herein.

Additionally, the catalyst produced by activation of the pre-catalyst may have an outstanding performance for production of hydrocarbons with carbon chain lengths suitable for fuel applications. In some embodiments, the production of hydrocarbons from CO₂ and H₂ using activated catalysts of the disclosure may produce C₅₊ hydrocarbons at a yield of 31 mol % or higher, such as from 33 mol % to 54 mol % on a carbon-carbon basis (i.e., percentage of carbon from CO₂ incorporated into C₅₊ hydrocarbons). Additionally, hydrocarbon production using the catalysts may produce less methane than comparable catalysts. For example, the selectivity for methane may be 6 mol % or less (i.e., less than 6% of the carbon liberated from CO₂ is incorporated into methane). Also, hydrocarbon production using the activated catalysts may coproduce oxygenated species, mostly aldehydes, ketones, alcohols, and acids at a higher yield than comparative catalyst,

### EXAMPLES

### Example 1—Synthesis of Pre-Catalysts

The pre-catalysts were prepared following a coprecipitation methodology. Initially, the desired amount of metal nitrates (e.g., iron nitrate, copper nitrate, and potassium nitrate for Fe—Cu—K pre-catalysts) was dissolved in 50 mL of deionized water and stirred for 10 min at room temperature. Then, different precipitation agents ((NH₄)₂CO₃, betaine (C₅H₁₁NO₂), tetraethylammonium bicarbonate (C₉H₂₁NO₃), triethylammonium bicarbonate (C₇H₁₇NO₃), choline bicarbonate solution (C₆H₁₅NO₄, approximately 80% in H₂O), or a mixture of them) were added dropwise to adjust the final pH to 6.5. Subsequently, the solution was aged at room temperature under stirring for 30 min. The solid was recovered by centrifugation, without any washing cycle, and then dried overnight at 100° C. Prior to reduction, the pre-catalyst was calcined under static air at 550° C. (10° C. min⁻¹).

### Example 2—Materials and Methods for Catalytic Studies

Catalytic tests were performed on an Avantium Flowrence XD unit with sixteen parallel channels operated with a stainless-steel fixed-bed reactor. The reactors were loaded with the activated catalyst and fed with a mixture of CO₂/H₂ (molar ratio of 1/3) at various gas hourly space velocities (GHSV). The reaction mixture was analyzed by online gas chromatography (GC).

In some cases, instead of online GC analysis, the product stream was direct to a separator set at −10° C. for the condensation of C₅₊ hydrocarbons. The liquid products were analyzed using off-line GC-flame ionization detection (GC-FID) (Agilent 7890A) and GC-mass spectrometry (GC-MS) (Agilent 7890A, MS 5977B MSD). GC-FID and GC-MS were used to define peaks qualitatively and quantitatively by HP-1MS (100 m×0.53 mm×0.25 μm) and Zebron-PONA (50 m×0.2 mm×0.50 μm) columns, respectively. Unknown compounds were identified by finding the matches of their retention times with multi standards and MS spectra in the NIST library (Version 2.0) and by knowledge of ion extracted peaks (McLafferty, F. W., & Turecek, F. Interpretation of Mass Spectra. University Science Books, Mill Valley, California. Fourth ed. (1993). https://doi.org/10.1002/bms.1200230614.

The molecular composition of liquid products was analyzed using GC×GC-time-of-flight mass spectrometry (GC-TOFMS) analysis on an Agilent GC×GC (model 7890B), which included a thermal modulator and a TOFMS detector from Joel (USA). Profiling was done in a normal phase configuration (a non-polar column used as the main capillary column (30 m×0.25 mm×0.25 μm) and a polar column (2 m×0.1 mm×0.1 μm) as the secondary column). All column sets and modulators were housed in a single oven. The GC×GC data was integrated and visualized using Zoex GC-Image software (version 6.0). The hydrocarbon classification for normal phase column configuration was determined similarly to the protocol described in ASTM UOP 990:2011 and U.S. Pat. No. 11,513,104. Additionally, peaks in the GC×GC/electron impact (EI) TOFMS chromatogram were identified by comparing their measured EI mass spectra with the NIST spectral library, considering their m/z values of the fragment ions typical for that compound type as mentioned elsewhere. Diesel and jet fuel standard references (AccuStandard) were used to validate results.

### Example 3—Testing of Fe—Cu—K Catalysts

Fe—Cu—K pre-catalysts were prepared with different Fe/Cu ratios, relative to a potassium (K) molar fraction of 0.05, as described in Example 1. Calcined pre-catalysts were reduced under diluted hydrogen (N₂/H₂ 50% v/v, 100 mL·min⁻¹) in situ at 400° C. (10° C. min⁻¹) for 1 hour.

Hydrocarbon synthesis was performed with experimental conditions including 30 bar, 350° C., GHSV 6450 mL·g⁻¹·h⁻¹, gas mix H₂:CO₂ in a molar ratio of 3. The results were tabulated in Table 1 and compared with catalysts containing only iron (Fe), only copper (Cu), Fe—Cu, Fe—K, or Cu—K. Copper and copper-potassium were mainly active for the reverse water gas shift reaction (CO). Iron was active in the direct conversion of CO₂ to C₅₊ hydrocarbons. By adding potassium, the fuel range (C₅₊) hydrocarbon yield increased from 20% to 29%.

TABLE 1
Catalytic performance for Fe—Cu—K based catalysts.

| | CO₂ | CO | | | | |
|---|---|---|---|---|---|---|
| | Conv./ | Select./ | HC Select./% | | | C₅₊ |
| Catalyst | % | % | CH₄ | C₂-C₄ | C₅₊ | yield/% |
| Fe | 36 | 13 | 9 | 23 | 55 | 20 |
| Fe₁—Cu₁ | 35 | 21 | 4 | 13 | 62 | 22 |
| Fe₁—Cu₂ | 34 | 15 | 7 | 17 | 61 | 21 |
| Cu | 26 | 94 | 2 | 2 | 2 | 1 |
| Fe—K_{0.05} | 47 | 8 | 7 | 25 | 60 | 28 |
| Fe₂—Cu₁—K_{0.05} | 43 | 13 | 7 | 17 | 63 | 27 |
| Fe₁—Cu₁—K_{0.05} | 46 | 12 | 7 | 17 | 64 | 29 |
| Fe₁—Cu₂—K_{0.05} | 45 | 11 | 6 | 15 | 68 | 31 |
| Fe₁—Cu₅—K_{0.05} | 44 | 14 | 7 | 17 | 62 | 27 |
| Fe₁—Cu₁₀—K_{0.05} | 40 | 16 | 6 | 16 | 62 | 25 |
| Cu—K_{0.05} | 18 | 98 | 0 | 1 | 1 | 0 |

Experimental conditions: 30 bar, 350° C., 6450 mL · g⁻¹ · h⁻¹, H₂/CO₂ molar ratio of 3.

The Fe—Cu—K catalysts were less prone to form short hydrocarbons and hence led to higher yields for fuel range hydrocarbons (C₅₊) compared to Fe and Fe—K. The Fe₁—Cu₂—K_{0.05} catalyst yielded 31% C₅₊ hydrocarbons Furthermore, Fe₁—Cu₂—K_{0.05} produced less methane than Fe and Fe—K_{0.05}.

The catalysts reported in Table 1 generally present a superior yield of C₅₊ hydrocarbons than catalysts previously reported, such as Fe—Mn—K and others listed in B. Yao, T. Xiao, O. A. Makgae, X. Jie, S. Gonzalez-Cortes, S. Guan, A. I. Kirkland, J. R. Dilworth, H. A. Al-Megren, S. M. Alshihri, P. J. Dobson, G. P. Owen, J. M. Thomas, P. P. Edwards, Transforming carbon dioxide into jet fuel using an organic combustion-synthesized Fe—Mn—K catalyst, Nature Communications, 11 (2020); U.S. Patent Application Publication No. US 2022/0184586; and International Patent Application Publication No. WO2020/201749.

The results reported in Table 1 show a higher C₅₊ selectivity with a similar CO₂ conversion for Fe—Cu—K catalysts when compared to other catalysts. For example, the C₅₊ hydrocarbon yield is about 7% higher than one other known catalyst (23.6 vs. 31%). Also, the Fe—Cu—K catalysts had acceptable methane selectivity and yield.

As mentioned earlier, incorporating a nitrogen precursor in the catalyst synthesis resulted in pre-catalysts that were activated to achieve high-performance catalysts. Supporting the theory that nitrogen in a pre-catalyst affects the overall activity and produced results, a Fe—Cu—K catalyst prepared by a methodology similar to Example 1 but using a nitrogen-free base (K₂CO₃) as the precipitating agent has been reported to yield 22% in C₅₊ hydrocarbons.

The catalysts listed in Table 1 were prepared using choline bicarbonate as base, precipitating agent, and source of nitrogen. However, as shown in Table 2, comparable catalytic performances were achieved when Fe₁—Cu₂—K_{0.05} was prepared using different nitrogen-containing bases, such as ammonium carbonate or a combination of betaine and ammonium carbonate. To reiterate, when the nitrogen-free base K₂CO₃ was used, the catalytic performance dropped considerably and 22% yield was obtained for C₅₊ hydrocarbons.

TABLE 2
Catalytic performance for Fe₁—Cu₂—K_{0.05} prepared
with different bases/nitrogen-sources.

| | CO₂ | CO | | | | |
|---|---|---|---|---|---|---|
| | Conv./ | Select./ | HC Select./% | | | C₅₊ |
| Base used | % | % | CH₄ | C₂-C₄ | C₅₊ | yield/% |
| Choline | 45 | 11 | 6 | 15 | 68 | 31 |
| bicarbonate | | | | | | |
| Ammonium | 21 | 51 | 6 | 14 | 29 | 6 |
| Carbonate | | | | | | |
| Betaine + | 33 | 20 | 7 | 19 | 54 | 18 |
| ammonium | | | | | | |
| carbonate | | | | | | |
| K₂CO₃ | 37 | 23 | 5 | 13 | 59 | 22 |

Experimental conditions: 30 bar, 350° C., 6450 mL · g⁻¹ · h⁻¹, H₂/CO₂ molar ratio of 3.

### Example 4—Analysis of Hydrocarbon Products

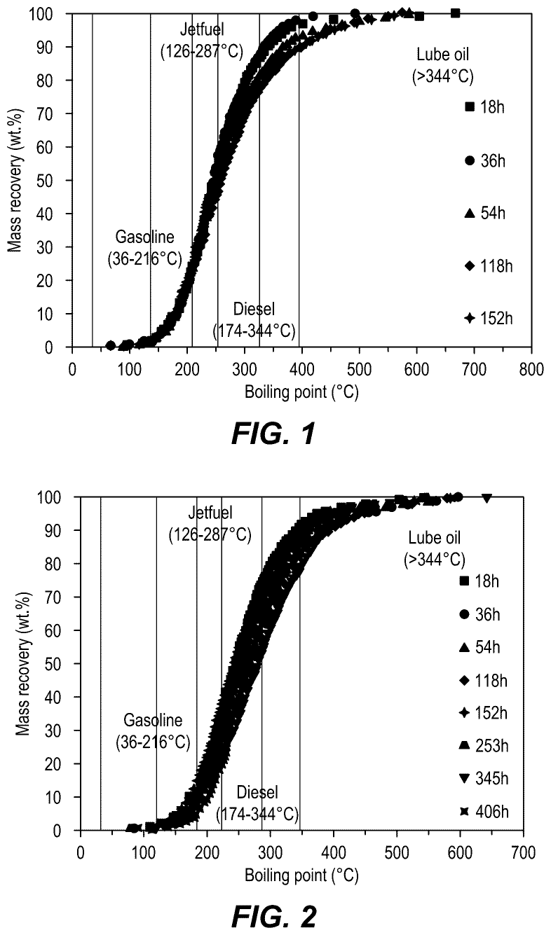

Liquid products made with Fe₁—K_{0.05} and Fe₁—Cu₂—K_{0.05} catalysts were separated in a liquid condenser at 25° C. and further analyzed. The liquids were collected at 18 hours, 36 hours, 54 hours, 118 hours, 152 hours, 253 hours, 345 hours, and 406 hours of time on stream, allowing identification of changes in liquid composition over time on stream. Boiling point distribution curves were calculated from SimDis and are presented in FIG. 1 (Fe₁—K_{0.05} catalyst) and FIG. 2 (Fe₁—Cu₂—K_{0.05} catalyst). Liquid fraction yields over time for the two catalysts are given in Table 3.

TABLE 3
Liquid fraction yields for the different reaction times.

| | Collection | Gasoline | Jet fuel | Diesel | Lube oil |
|---|---|---|---|---|---|
| Catalyst | time (h) | (C₇₋₁₂) | (C₈₋₁₆) | (C₁₀₋₂₀) | (C₂₀₊) |
| Fe₁—K_{0.05} | 0-18 | 31 | 71 | 81 | 5 |
| | 18-36 | 30 | 71 | 83 | 8 |
| | 36-54 | 31 | 67 | 76 | 14 |
| | 100-118 | 28 | 63 | 73 | 18 |
| | 134-152 | 30 | 64 | 72 | 16 |
| Fe₁—Cu₂—K_{0.05} | 0-18 | 40 | 78 | 80 | 4 |
| | 18-36 | 40 | 74 | 74 | 9 |
| | 36-54 | 38 | 71 | 74 | 11 |
| | 100-118 | 30 | 70 | 75 | 15 |
| | 134-152 | 33 | 69 | 78 | 11 |
| | 235-253 | 27 | 67 | 80 | 13 |
| | 327-345 | 24 | 64 | 78 | 15 |
| | 382-406 | 19 | 63 | 79 | 16 |

C₅ to C₆ hydrocarbons were not analyzed.

The boiling point distribution curves (calculated from SimDis) revealed the presence of hydrocarbons that could be used as gasoline (boiling point up to 216° C.), jet fuel (boiling point range 126-287° C.), and diesel fuel (boiling point range 174-344° C.) (Table 3, FIG. 2 and Table 3). The heavier fraction, named lube oil, was obtained at a temperature above 344° C. The overlapping temperature ranges of these fractions explain how the sum of the fractions of the liquid component in Table 3 was more than 100%.

As a general trend, Fe₁—Cu₂—K_{0.05} generated a greater relative concentration of gasoline, jet fuel, and diesel fraction than Fe₁—K_{0.05}. For the Fe₁—K_{0.05} catalyst, the gasoline fraction remained constant during the first 150 hours on of reaction. However, the heavier fractions, diesel and jet fuel, decreased by 7 and 9 wt. %, respectively, while lube oil fraction increased from 5 to 16 wt. %.

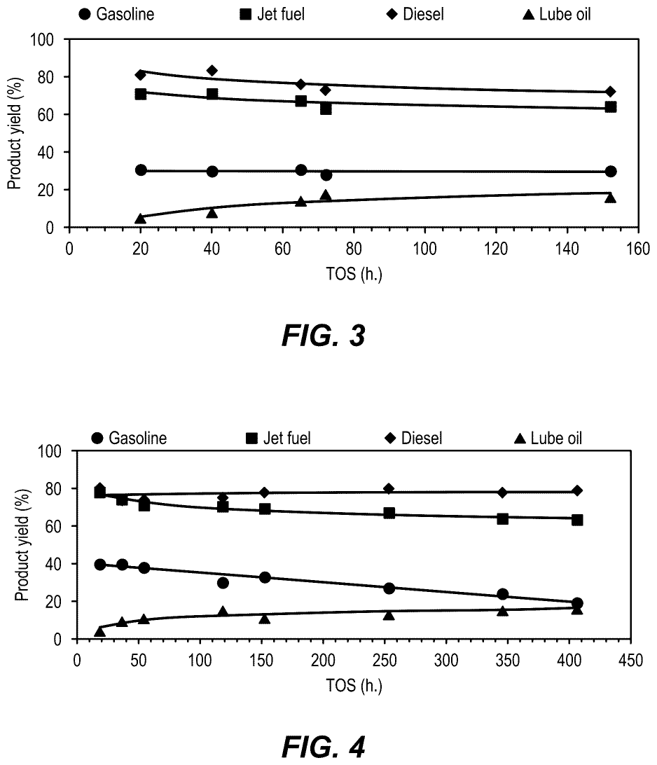

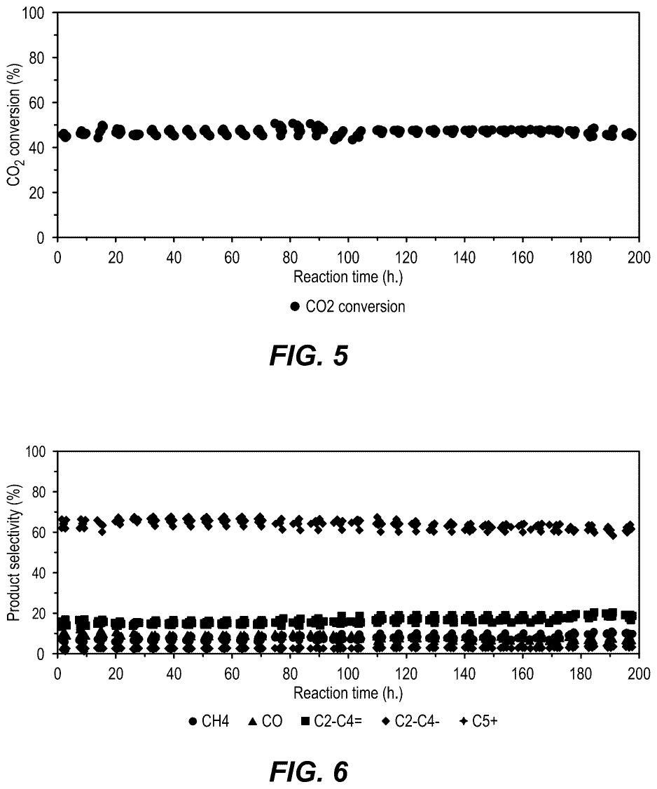

Additionally, Fe₁—Cu₂—K_{0.05} produced less lube oil (11 wt %), yet with a superior productivity of the fuel fractions. At longer reaction times, Fe₁—Cu₂—K_{0.05} showed a steady decrease in the gasoline range and stable productivity of the jet fuel and diesel fractions (FIGS. 3 and 4 and Table 3).

The liquid products of Fe₁—K_{0.05} and Fe₁—Cu₂—K_{0.05} catalysts in fuel ranges were analyzed in more detail. As summarized in Table 4, the representative GC spectra of liquid products were collected from 0 hours to 100 hours and the wt % of all hydrocarbon families (olefins, paraffin, aromatics, naphthenes) in the gasoline and jet fuel range were tabulated. The major components in samples produced by either catalyst were olefins, followed by paraffins, with minor observations of aromatics and naphthenes.

TABLE 4
Chemical composition of the liquids collected

| | Collection time (h) | | | | | |
|---|---|---|---|---|---|---|
| | Fe₁—K_{0.05} | | Fe₁—Cu₂—K_{0.05} | | | |
| Product | 0-20 | 65-100 | 0-20 | 20-40 | 40-65 | 65-100 |
| Paraffin | 11.68 | 13.18 | 14.66 | 13.40 | 13.39 | 10.97 |
| Iso-Paraffin | 7.57 | 7.96 | 8.25 | 8.97 | 7.30 | 7.08 |
| Aromatics | 3.22 | 2.41 | 9.99 | 9.81 | 9.77 | 9.42 |
| Mono aromatics | 0.31 | 0.73 | 5.54 | 5.05 | 6.57 | 5.10 |
| Naphthalenes | 1.70 | 0.63 | 3.26 | 3.88 | 2.27 | 2.21 |
| Indanes | 0.79 | 0.43 | 1.18 | 0.87 | 0.92 | 2.06 |
| Indenes | 0.42 | 0.63 | 0 | 0 | 0 | 0.04 |
| Naphthenes | 3.84 | 2.35 | 5.13 | 3.99 | 4.45 | 4.16 |
| Mono-Naphthenes | 3.23 | 1.45 | 4.70 | 3.45 | 3.77 | 3.60 |
| Di/Bicyclo- | 0 | 0.41 | 0.26 | 0.41 | 0.34 | 0.19 |
| Naphthenes | | | | | | |
| Olefins | 55.84 | 59.88 | 53.38 | 53.16 | 57.64 | 59 |
| n-Olefins | 48.38 | 54.37 | 45.27 | 46.96 | 50.03 | 52.67 |
| Iso-Olefins | 6.52 | 5.38 | 6.97 | 5.45 | 6.23 | 5.72 |
| Naphtheno-Olefins | 0.78 | 0.14 | 0.65 | 0.29 | 0.79 | 0.03 |
| Di-Olefins | 0.18 | 0.47 | 0.51 | 0.47 | 0.59 | 0.59 |
| Oxygenates | 0.23 | 0 | 1.69 | 0.98 | 1.47 | 1.07 |
| Unidentified | 17.61 | 14.21 | 6.88 | 9.70 | 5.97 | 8.29 |

The Fe₁—K_{0.05} catalysts had an increased production of paraffins and isoparaffins over time. In contrast, the Fe₁Cu₂—K_{0.05} catalyst had a decrease in total fraction of paraffins with increased reaction time, with a decrease of the paraffin fraction by almost 4 wt. % and the iso-paraffins by 1.2 wt. %. Additionally, the major component produced by both catalysts, olefins (more than 50 wt. % in these fuel-range samples) increased by 5 wt. % within the first 100 hours of reaction, with an increase in n-olefins and a decrease in iso-olefins. However, the production of aromatic and naphthene species was reduced as the reaction time increased. Without being bound by theory, the decrease in aromatic and naphthene production suggests a transformation of aromatic species into olefins and paraffins, respectively, by carbon ring breakage.

In addition, it is noteworthy that the tested fuel-range products contained fewer slight aromatics (mono aromatics and napththalenes) and naphthenes (typically, toluene, xylene, and some polyaromatic hydrocarbons) than commercial jet fuel.

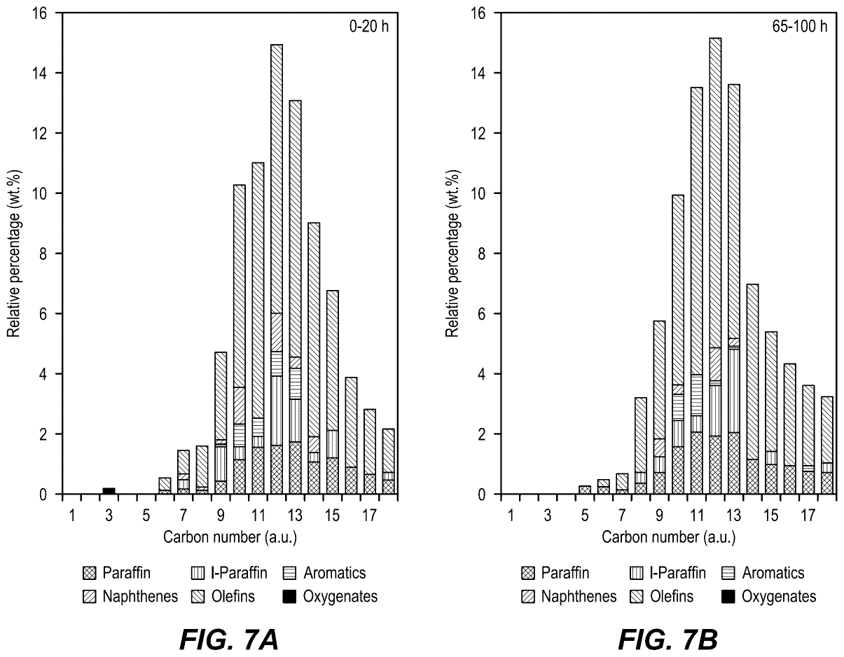

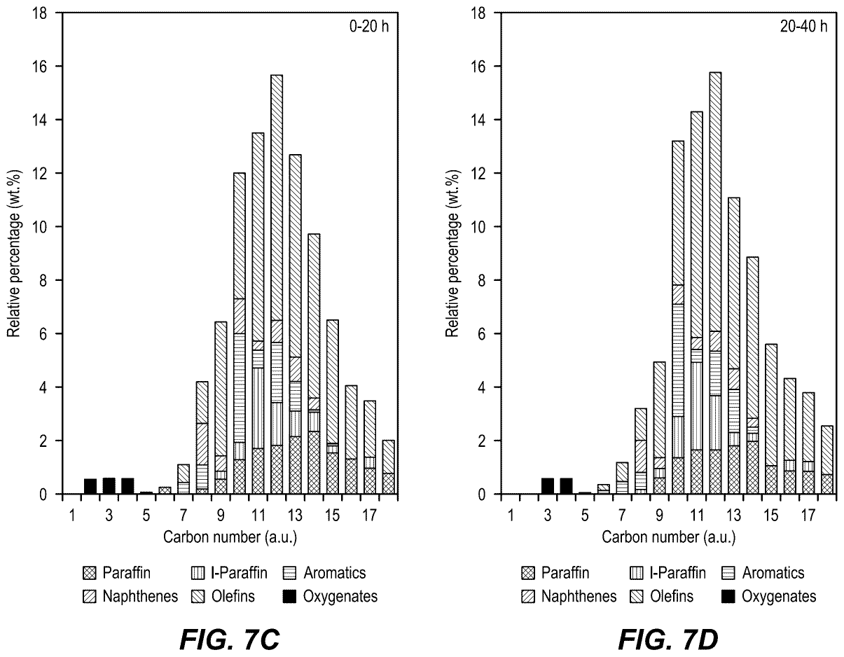

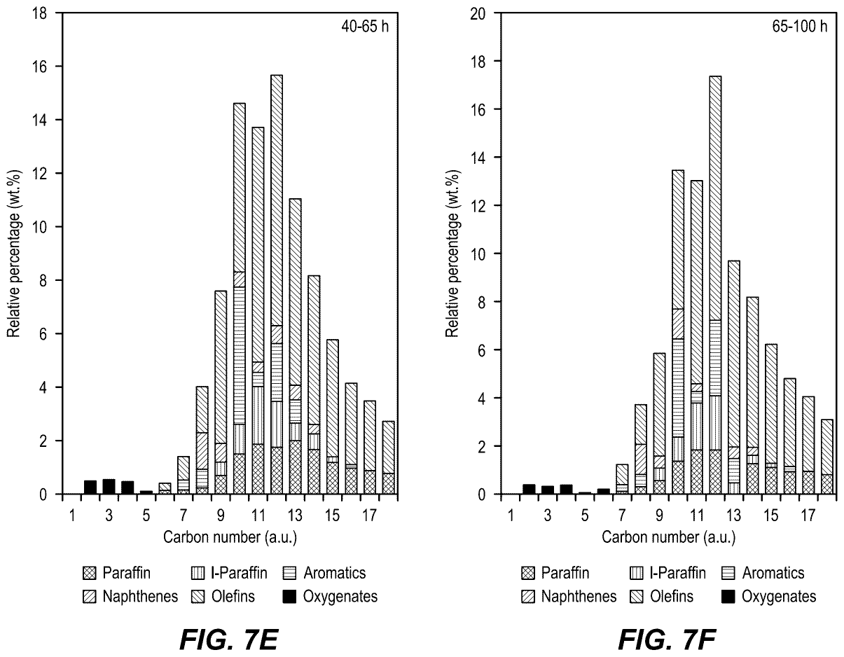

According to the carbon number analysis in FIGS. 7A-7F, all the produced species showed a maximum between C₉-C₁₃. The distribution did not change significantly with the reaction time.

The presence of oxygenated species with carbon numbers C₂, C₃, C₄, and C₅, was noticeable in fuel-range products of the Fe₁Cu₂—K_{0.05} catalyst, while such species were negligible in the products of the Fe₁—K_{0.05} catalyst, indicating that the presence of copper in the sample increased the yield of these oxygenated species.

In both catalysts, the major components (olefins and paraffins) reached a maximum around C₁₂-C₁₃, whereas the aromatics peaked at lower carbon numbers, C₉-C₁₀.

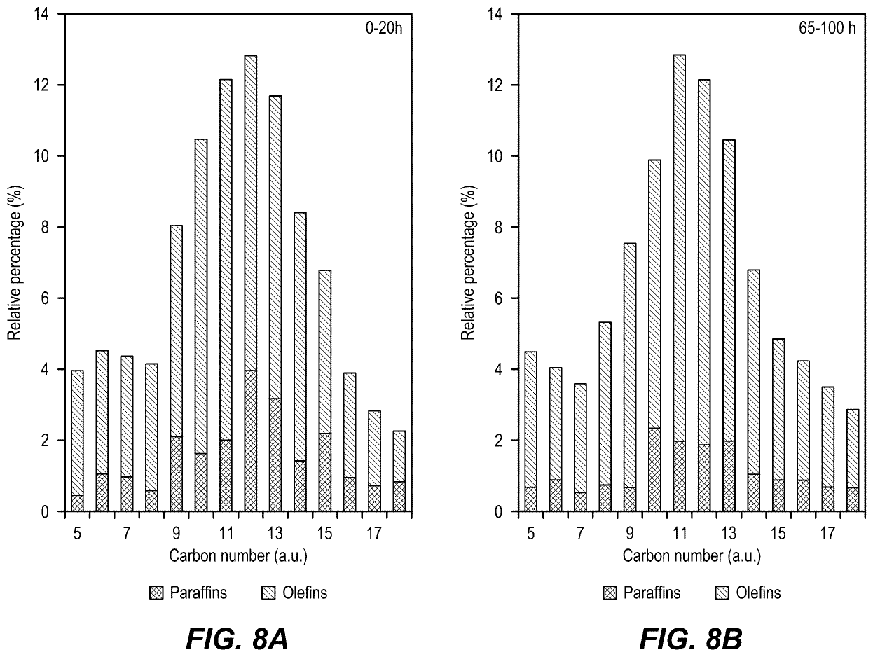

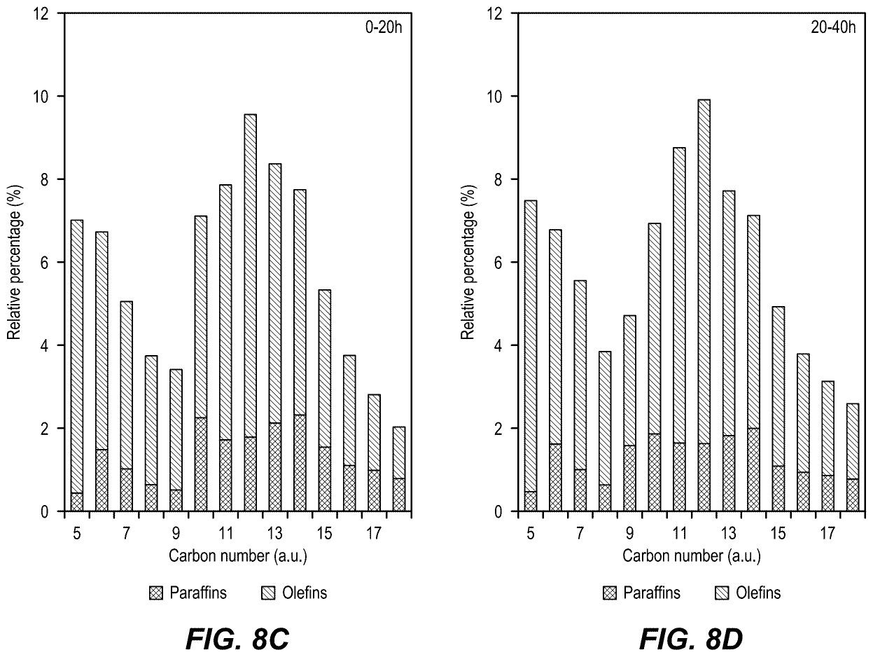

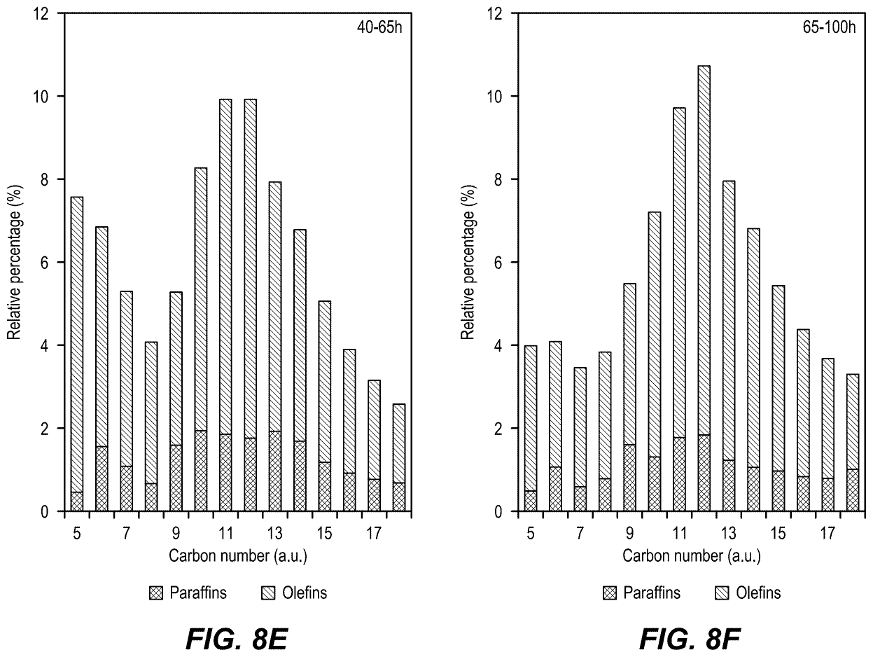

However, the asymmetric shape of all product distribution curves for both catalysts is curious, exhibiting a low production of C₅, C₆, C₇ and C₈ hydrocarbons. To see if this was an effect of the experimental liquid collection procedure, the fraction of C₅₊ heavy hydrocarbons detected in the gas phase was added, as shown in FIGS. 8A-8F.

The presence of copper in the catalyst increased the number of aromatics and oxygenated species in the fuel.

In all analyses, the maximum percentage of unknown products remained below 17 wt. %.

As shown in FIGS. 8A-8F, when the yields of products in terms of paraffins and olefins in the gas and liquid phases were combined, the product distribution became more symmetrical. The yields were detected in the gas phase by GC from C₅ to C₁₂. Since the collection temperature was approximately 25° C., most of the lighter hydrocarbons (C₅-C₈) were not totally collected. However, some lighter hydrocarbons were detected in the GC. It is noted that as the reaction time increased, the light hydrocarbon fraction decreased, and the heavier fractions increased. This difference was most noticeable for the Fe₁Cu₂—K_{0.05} catalyst (FIGS. 8C-8F) than for the Fe₁—K_{0.05} catalyst (FIGS. 8A-8B).

In general, the major component found for C₅ to C₆ during the first 100 hours of reaction was an n-paraffin (n-pentane and n-hexane, respectively), while from C₇ to C₁₈, the major component was an n-olefin (1-heptane, trans-4-octene, cis-2-nonene, 4-decene, 1-undecene, 1-dodecene, 1-tridecene, 1-tetradecene, 1-pentadecene, 1-hexadecene, 1-heptadecene, and 1-octadecene).

### Example 5—Effect of Reaction Conditions Using Fe₁—Cu₂—K_{0.05} as Catalyst

Fe₁—Cu₂—K_{0.05} catalyst was studied at different reaction conditions to understand the effect of temperature (Table 5), pressure (Table 6), gas hourly space velocity (Table 7), and H₂/CO₂ molar ratio (Table 8) on CO₂ conversion and product distribution.

As shown in Table 5, the highest CO₂ conversion and C₅₊ selectivity was obtained at temperatures between 350° C. and 375° C.

TABLE 5
Effect of temperature on performance of Fe₁—Cu₂—K_{0.05}

| | CO₂ | CO | | | | |
|---|---|---|---|---|---|---|
| Temperature/ | Conv./ | Select./ | HC Select./% | | | C₅₊ |
| ° C. | % | % | CH₄ | C₂-C₄ | C₅₊ | yield/% |
| 300 | 25 | 32 | 4 | 12 | 52 | 13 |
| 325 | 36 | 16 | 5 | 16 | 63 | 23 |
| 350 | 45 | 11 | 6 | 15 | 68 | 31 |
| 375 | 50 | 11 | 7 | 16 | 66 | 33 |
| 400 | 50 | 15 | 10 | 14 | 61 | 31 |

Reaction conditions: 30 bar, 6450 mL · g⁻¹ · h⁻¹, H₂/CO₂ molar ratio of 3.

The pressure had a significant effect on the catalyst performance. Both CO₂ conversion and selectivity toward heavy hydrocarbons were highest at pressures of 25 bar and above. At lower pressures (15-20 bar) carbon monoxide productivity increased at the expense of C₅₊ yield.

TABLE 6
Effect of pressure on performance of Fe₁—Cu₂—K_{0.05}

| | CO₂ | CO | | | | |
|---|---|---|---|---|---|---|
| Pressure/ | Conv./ | Select./ | HC Select./% | | | C₅₊ |
| bar | % | % | CH₄ | C₂-C₄ | C₅₊ | yield/% |
| 15 | 38 | 21 | 5 | 14 | 60 | 23 |
| 20 | 41 | 16 | 5 | 14 | 65 | 27 |
| 25 | 44 | 13 | 5 | 15 | 67 | 29 |
| 30 | 45 | 11 | 6 | 15 | 68 | 31 |
| 35 | 48 | 9 | 5 | 16 | 70 | 34 |
| 40 | 48 | 8 | 6 | 17 | 69 | 33 |
| 45 | 47 | 9 | 6 | 17 | 68 | 32 |
| 50 | 46 | 10 | 6 | 16 | 68 | 31 |

Reaction conditions: 350° C., 6450 mL · g⁻¹ · h⁻¹, H₂/CO₂ molar ratio of 3.

Similar catalytic performance was observed for gas hourly space velocity (GHSV) of 3225 mL·g⁻¹·h⁻¹ and 6450 mL·g⁻¹·h⁻¹. Increasing the GHSV to 12,900 mL·g⁻¹·h⁻¹ led to a reduction in the C₅₊ yield to 27%.

TABLE 7
Effect of the gas hourly space velocity in
the performance of Fe₁—Cu₂—K_{0.05}.

| GHSV/ | CO₂ | CO | | | | |
|---|---|---|---|---|---|---|
| mL · g⁻¹ · | Conv./ | Select./ | HC Select./% | | | C₅₊ |
| h⁻¹ | % | % | CH₄ | C₂-C₄ | C₅₊ | yield/% |
| 3225 | 46 | 11 | 5 | 16 | 68 | 31 |
| 6450 | 45 | 11 | 6 | 15 | 68 | 31 |
| 12900 | 42 | 14 | 5 | 16 | 65 | 27 |

Reaction conditions: 30 bar, 0.05 g of catalyst, 350° C. and H₂/CO₂ molar ratio of 3.

The effect of the H₂/CO₂ ratio was studied at 30 bar and 350° C. The conversion and methane selectivity increased along with the H₂/CO₂ ratio, while product distribution C₅₊ selectivity was greatest for ratios between 2 and 3, reaching a maximum at H₂/CO₂=2.

TABLE 8
Effect of the H₂/CO₂ ratio in the performance of Fe₁—Cu₂—K_{0.05}.

| H₂/ | | | | | | |
|---|---|---|---|---|---|---|
| CO₂ | CO₂ | CO | | | | |
| molar | Conv./ | Select./ | HC Select./% | | | C₅₊ |
| ratio | % | % | CH₄ | C₂-C₄ | C₅₊ | yield/% |
| 1 | 20 | 23 | 4 | 13 | 60 | 12 |
| 2 | 35 | 13 | 7 | 20 | 60 | 21 |
| 2.5 | 39 | 12 | 6 | 17 | 65 | 25 |
| 3 | 45 | 11 | 6 | 15 | 68 | 31 |

Reaction conditions: 30 bar, 350° C., and 6450 mL · g⁻¹ · h⁻¹.

### Example 6—Effect of Co-Metal in Fe-Based Catalysts

In addition to copper, catalysts comprising other metals were also tested for the direct conversion of CO₂ to fuels (Table 9). In all cases C₅₊ hydrocarbons were formed, reaching the best C₅₊ yields for a Fe—Co catalyst. Along with Fe—Co, Fe—Pd, and Fe—Mn display higher C₅₊ hydrocarbon yields than Fe—Cu. However, these results were inferior to the Fe₁—Cu₂—K_{0.05} catalyst reported herein (e.g., Table 8, H₂/CO₂=3). The other catalysts were mainly selective to CO and C₁-C₄ hydrocarbons.

TABLE 9
Effect of co-metal in Fe-based catalysts.

| | CO₂ | CO | | | | |
|---|---|---|---|---|---|---|
| | Conv./ | Select./ | HC Select./% | | | C₅₊ |
| Catalysts | % | % | CH₄ | C₂-C₄ | C₅₊ | yield/% |
| Fe—Cu | 35 | 21 | 4 | 13 | 62 | 22 |
| Fe—Pd | 44 | 14 | 6 | 20 | 60 | 26 |
| Fe—Mn | 40 | 11 | 9 | 22 | 58 | 23 |
| Fe—Ag | 33 | 21 | 13 | 21 | 45 | 15 |
| Fe—Nb | 33 | 13 | 19 | 23 | 45 | 15 |
| Fe—V | 18 | 59 | 11 | 8 | 22 | 4 |
| Fe—La | 15 | 63 | 12 | 5 | 20 | 3 |
| Fe—Ga | 10 | 59 | 16 | 6 | 19 | 2 |
| Fe—Gd | 10 | 51 | 15 | 6 | 28 | 3 |
| Fe—Cr | 31 | 31 | 17 | 16 | 36 | 11 |
| Fe—Zn | 36 | 12 | 20 | 21 | 47 | 17 |
| Fe—Co | 62 | 2 | 22 | 28 | 48 | 30 |
| Fe | 36 | 13 | 9 | 23 | 55 | 20 |

Reaction conditions: 30 bar, 350° C., 6450 mL · g⁻¹ · h⁻¹ and H₂/CO₂ molar ratio of 3.

### Example 7—Effect of Co-Metal in Fe—Cu—K-Based Catalysts

Tetrametallic catalysts with molar composition Fe₁-M_{0.5}-Cu₂—K_{0.05}, where M=La, V, Cr, Pd, Gd, Fa, Mn, Zn, Co, or Ni, were also tested for the direct conversion of CO₂ to fuels (Table 10). Fe₁—Pd_{0.5}—Cu₂—K_{0.05} displayed a superior C₅₊ yield and inferior CH₄ selectivity compared to Fe—Cu₂—K_{0.05}. Fe₁—V_{0.5}—Cu₂—K_{0.05}, Fe₁—Cr_{0.5}—Cu₂—K_{0.05}, Fe₁—Ga_{0.5}—Cu₂—K_{0.05}, Fe₁—Mn_{0.5}—Cu₂—K_{0.05}, and Fe—Zn_{0.5}—Cu₂—K_{0.05} achieved C₅₊ yield and comparable to Fe₅—Cu₂—K_{0.05}.

The catalyst Fe₁—Pd_{0.5}—Cu₂—K_{0.05} achieved a yield for C₅₊ and CH₄ of 54 mol % and 5 mol %, respectively.

TABLE 10
Effect of additional metal in Fe—Cu—K-based catalysts.

| | CO₂ Conv/ | CO Select./ | HC Select/% | | | C₅₊ |
|---|---|---|---|---|---|---|
| Catalyst | % | % | CH₄ | C₂-C₄ | C₅₊ | yield/% |
| Fe₁—La_{0.5}—Cu₂—K_{0.05} | 35 | 78 | 5 | 3 | 13 | 5 |
| Fe₁—V_{0.5}—Cu₂—K_{0.05} | 53 | 13 | 6 | 18 | 62 | 33 |
| Fe₁—Cr_{0.5}—Cu₂—K_{0.05} | 50 | 15 | 8 | 21 | 56 | 28 |
| Fe₁—Pd_{0.5}—Cu₂—K_{0.05} | 72 | 7 | 5 | 13 | 75 | 54 |
| Fe₁—Gd_{0.5}—Cu₂—K_{0.05} | 36 | 52 | 9 | 13 | 26 | 9 |
| Fe₁—Ga_{0.5}—Cu₂—K_{0.05} | 52 | 13 | 8 | 19 | 60 | 31 |
| Fe₁—Mn_{0.5}—Cu₂—K_{0.05} | 44 | 12 | 6 | 15 | 67 | 30 |
| Fe₁—Zn_{0.5}—Cu₂—K_{0.05} | 43 | 14 | 6 | 15 | 65 | 28 |
| Fe₁—Co_{0.5}—Cu₂—K_{0.05} | 41 | 14 | 10 | 19 | 56 | 23 |

Reaction conditions: 30 bar, 350° C., 6450 mL · g⁻¹ · h⁻¹, and H₂/CO₂ molar ratio of 3.

### Example 8: Scale Up of the Catalyst Synthesis

The synthesis of the Fe₁Cu₂—K_{0.05} catalyst using choline bicarbonate of Example 1 was scaled up 10-fold, 50-fold, and 100-fold. The final catalyst yield increased from 1.05 g per synthesis (Example 1) to 84 g of catalyst per synthesis (100-fold scale up).

The catalytic behavior of the different scaled-up catalysts was tested at 30 bar, 350° C., 6450 mL·g⁻¹·h⁻¹, and H₂/CO₂ molar ratio of 3). No significant differences were seen between the samples prepared at different scales of the Fe₁Cu₂K_{0.05} catalyst. These results suggest that the catalyst synthesis process is fully scalable up to 100 times the scale of Example 1.

### Example 9—Characterization of Calcined Pre-Catalysts

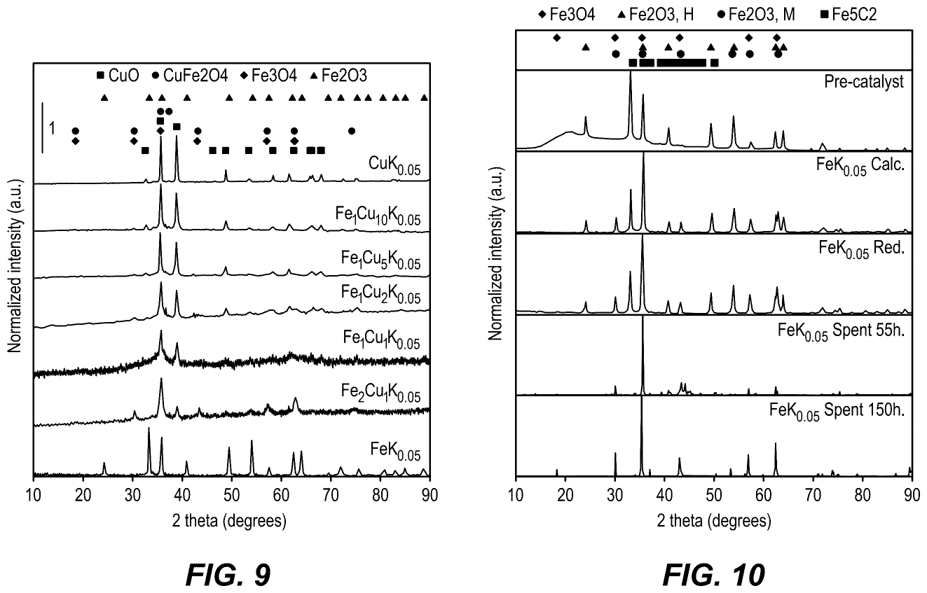

Calcined pre-catalysts CuK_{0.05}, Fe₁Cu₁₀K_{0.05}, Fe₁Cu₅K_{0.05}, Fe₁Cu₂K_{0.05}, Fe₁Cu₁K_{0.05}, Fe₂Cu₁K_{0.05}, and FeK_{0.05} were characterized by XRD, as shown in FIG. 9.

As an overall observation, the CuFe₂O₄ phase was present along with the expected Fe₃O₄, Fe₂O₃, and CuO phases in the FeₓCu_{y}K_{0.05} samples. By analyzing the samples one by one, some differences between them were observed. For one, an excess of iron in the catalysts led to the direct formation of the hematite phase, (Fe₂O₃, characteristic peak at 24.10, catalyst Fe₁—K_{0.05}). Also, a peak appears at 36.5° characteristic of the cuprite phase of copper, Cu₂O, in sample Fe₂Cu₁K_{0.05}, suggesting higher copper reducibility in this sample. In addition, the characteristic peaks of the magnetite phase (Fe₃O₄, 35.8°, 63.2°) also appeared with copper addition. Furthermore, as the Fe/Cu ratio decreased in the series, peaks characteristic of the different double mixed oxides, CuFeₓO_{y} were visible, in addition to peaks characteristic of the tenorite phase, CuO.

Generally, as the proportion of copper in the catalysts increased, the peaks at 35° and 38°, corresponding to the tenorite phase, also increased.

In both samples Fe₂Cu₁K_{0.05} and Fe₁Cu₂K_{0.05}, a more intense peak at 36.5°, corresponding to the cuprite phase, Cu₂O, appeared compared to the other catalysts. This suggests that in these samples a portion of copper is more easily reducible, which could explain the improvement in the catalytic activity with respect to the rest of the samples.

### Example 10—Characterization of Reduced and Spent Catalysts

To determine the species present in the catalyst after reduction and use, X-ray diffractograms for the reduced and spent Fe—K_{0.05} and Fe₁Cu₂—K_{0.05} samples after several hours of reaction were prepared as shown in FIGS. 12-15. FIG. 10 and FIG. 12 also show XRD results for the pre-catalyst and calcined pre-catalyst forms of the FeK_{0.05} and FeCu₂K_{0.05} samples, respectively.

The results shown in FIG. 10 indicate that the reduced Fe—K_{0.05} catalyst had characteristic peaks of the hematite phase, Fe₂O₃, H, and the magnetite phase, Fe₃O₄, M, in relative proportions of 60% and 40%, respectively calculated by semi-quantitative analysis. The average size calculated by the Scherrer equation was 64 nm for hematite and 48 nm for magnetite.

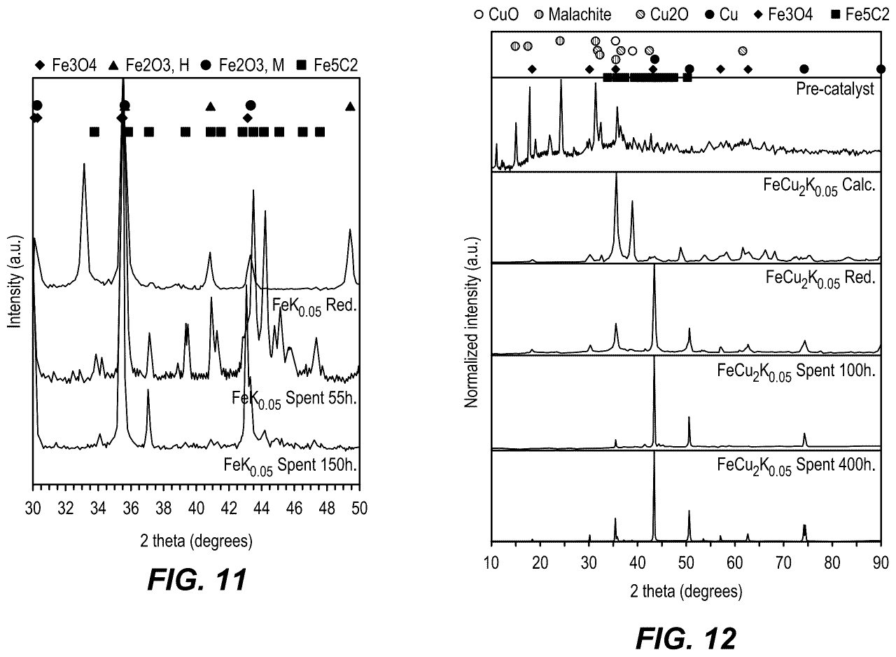

In FIG. 11, the results indicated that after 55 hours of reaction, the peak associated with the hematite phase Fe₂O₃, disappeared completely in the Fe—K_{0.05} sample. Peaks appeared at 40.9°, 43.5°, 44.2°, 45°, and 46.5° that were associated with the iron carbide phase, Fe₅C₂(Hägg carbide). However, the peak that signals the magnetite phase remained intact. The disappearance of the Fe₂O₃ peak suggests that the Fe₂O₃ transformed into iron carbides, which have been previously proposed in the literature as the active phase of the FTS reaction.

After 150 hours of reaction, the characteristic peaks of the iron carbide phase (Fe₅C₂, Hägg carbide) are attenuated, indicating the transformation of this species with reaction time. In addition, the intensity of the peaks associated with magnetite increased considerably, indicating a sintering of magnetite, with an average size of 180 nm after 150 hours of reaction. This observation could be associated with the deactivation of the catalyst.

In the reduced Fe₁Cu₂—K_{0.05} catalyst, the copper was fully reduced to metallic copper, characteristic peak at 43.3°, and the iron was in the magnetite phase, Fe₃O₄, with average particle size of 88 nm and 42 nm, as shown in FIG. 12.

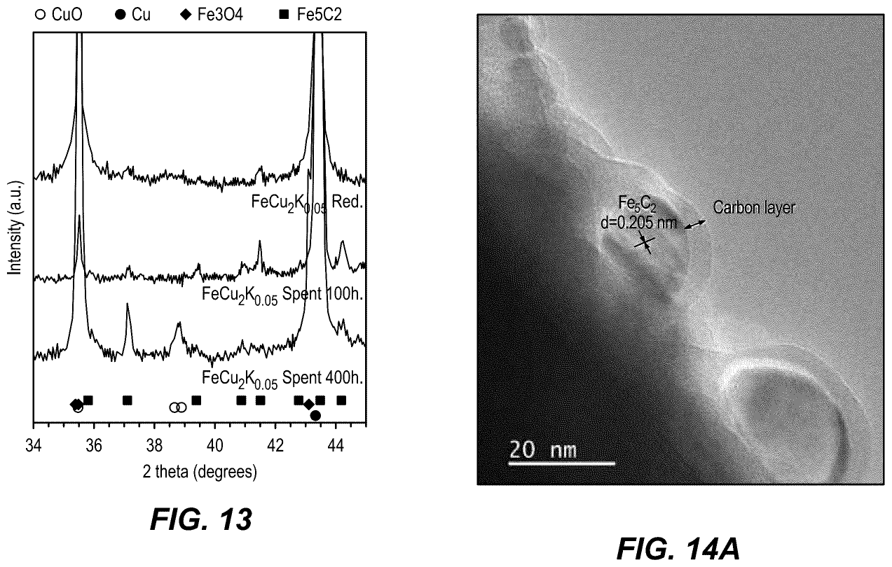

After 100 hours of reaction, the Fe₁Cu₂—K_{0.05} catalyst showed sintering of the magnetite phase, 80 nm, while the metallic copper phase maintained its average size, 96 nm. The diffraction peaks characteristic of iron carbide were also observed in this catalyst, as shown in FIG. 13. Unlike the iron-potassium catalyst, after 100 hours of reaction, the magnetite phase had less sintering. This may represent preferential sintering of copper and reduced sintering of the iron phase. After more than 400 hours of reaction, the magnetite phase also sintered, with an estimated average size of 91 nm, in addition to the metallic copper, which had a final average size of 126 nm.

Chemical compositions were evaluated by X-ray fluorescence (XRF). As shown in Table 11, the determined molar fraction was similar to the nominal value, confirming the effectiveness of the synthesis methodology.

TABLE 11
The catalyst composition of the calcined
and spent catalysts by XRF.

| | | | | Chemical composition | | | |
|---|---|---|---|---|---|---|---|
| | Nominal molar ratios | | | by XRF (wt. %) | | | |
| Catalyst | Fe | Cu | K | Fe | Cu | K | Fe/Cu |
| Fe₁—Cu₂—K_{0.05} | 1.0 | 2.0 | 0.05 | 13 | 27 | 0.2 | 0.5 |
| pre-catalyst | | | | | | | |
| Fe₁—K_{0.05} | 1.0 | 0 | 0.05 | 56 | — | 1.4 | — |
| Fe₁Cu₁—K_{0.05} | 1.0 | 0.7 | 0.02 | 37 | 28 | 0.4 | 1.3 |
| Fe₂Cu₁—K_{0.05} | 2.0 | 0.9 | 0.06 | 41 | 22 | 0.9 | 1.8 |
| Fe₁Cu₂—K_{0.05} | 1.0 | 2.0 | 0.05 | 21 | 43 | 0.3 | 0.5 |
| K₂CO₃, Fe₁Cu₂—Kₓ | 1.0 | 2.0 | — | 23 | 55 | 14 | 0.4 |
| (NH₄)₂CO₃, | 1.0 | 2.0 | 0.05 | 21 | 40 | 0.5 | 0.5 |
| Fe₁Cu₂K_{0.05} | | | | | | | |
| Betaine + | 1.0 | 2.0 | 0.05 | 24 | 42 | 0.5 | 0.5 |
| (NH₄)₂CO₃, | | | | | | | |
| Fe₁Cu₂K_{0.05} | | | | | | | |
| *Choline, | 1.0 | 2.0 | 0.05 | 21 | 43 | 0.5 | 0.5 |
| Fe₁Cu₂—K_{0.05} | | | | | | | |
| Fe₁—K_{0.05} Spent | 1.0 | 0 | 0.05 | 24 | 42 | 0.5 | 0.5 |
| 55 h | | | | | | | |
| Fe₁—K_{0.05} Spent | 1.0 | 0 | 0.05 | 46 | — | 1.4 | — |
| 150 h | | | | | | | |
| Fe₁Cu₂—K_{0.05} | 1.0 | 2.0 | 0.05 | 21 | 40 | 0.5 | 0.5 |
| Spent 100 h | | | | | | | |
| Fe₁Cu₂—K_{0.05} | 1.0 | 2.0 | 0.05 | 22 | 44 | 0.2 | 0.5 |
| Spent 400 h | | | | | | | |

The chemical analysis of the catalysts prepared by modifying the Cu/Fe ratio showed the good adaptability of the synthesis process with the resulting metal loading. The percentage of potassium in the Fe catalyst was higher than in the Fe—Cu catalyst, 1.4 vs. 0.300, respectively.

In addition, the chemical composition of the spent catalyst after 55-400 hours of reaction was very close to that of the fresh one, which suggests that any metal leaching during the reaction was minimal.

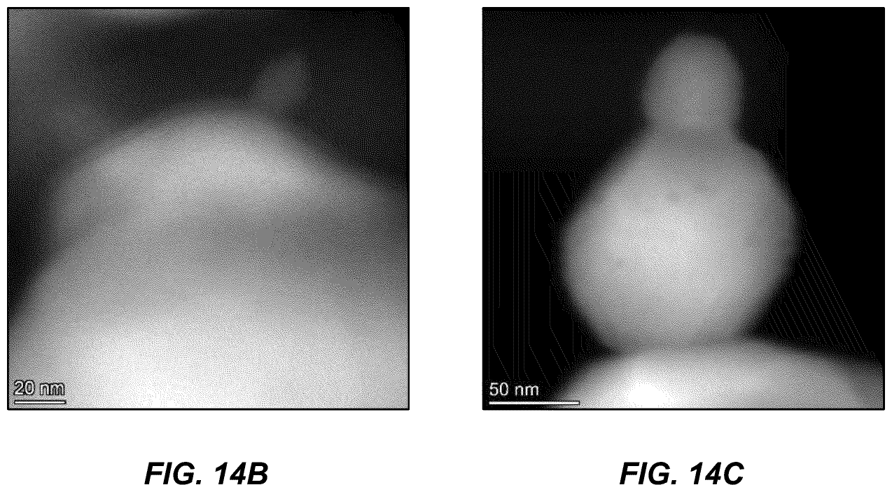

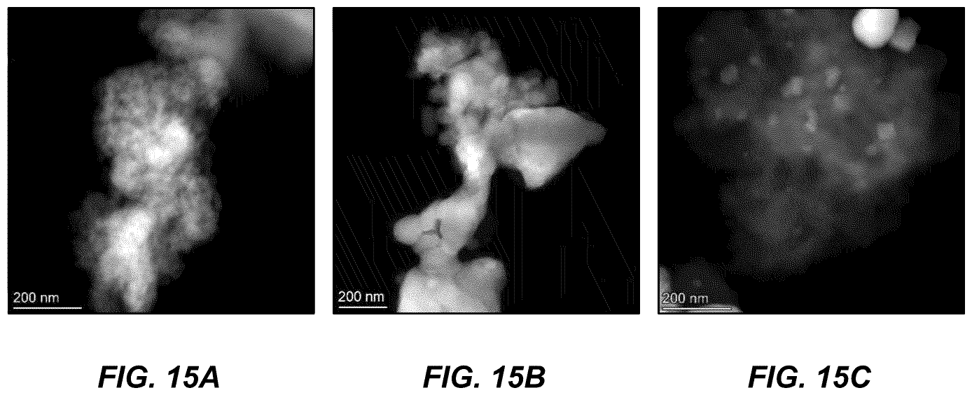

FIGS. 14A-15C provides analyses of the samples by electron microscopy to observe the morphology and surface of the catalysts. The transmission electron microscopy provided evidence that there were iron carbides in the Fe₁Cu₂—K_{0.05} spent catalyst after 100 hours of reaction (FIG. 15B).

In Table 12, the non-metal chemical content of the FeCu₂K_{0.05} catalysts are recorded.

TABLE 12
Characteristics of the FeCu₂K_{0.05} Pre-catalyst and Catalyst

| | Nitrogen | Carbon | Hydrogen | Sulphur | Oxygen |
|---|---|---|---|---|---|
| Sample | (wt %) | (wt %) | (wt %) | (wt %) | (wt %) |
| Pre-catalyst | 7.5 | 16.7 | 3.4 | 0 | 36.7 |
| FeCu₂K_{0.05} | | | | | |
| FeCu₂K_{0.05} | 0.07 | 1.5 | 0.3 | 0 | 4.1 |
| activated | | | | | |
| FeCu₂K_{0.05} after | 0.05 | 21.7 | 0.9 | 0 | 16.6 |
| 400 h operation | | | | | |

Approximately 7.5 wt. % of nitrogen was present in the pre-catalyst before loading into the reactor. During the pre-catalyst activation process described in Example 3, the nitrogen content was reduced to 0.07 wt. %. After 400 h of operation, the nitrogen loading was 0.05 wt. %.

Without being bound by theory, it is believed that nitrogen created a chemical environment in the pre-catalysts that, when activated, generated a catalyst with significantly higher performance, e.g., higher yield of C₅₊ hydrocarbons and lower selectivity for methane.

Embodiments disclosed herein include:

A. A method of making a catalyst, comprising: dissolving one or more metal salts in water to form a solution, wherein the metal salts comprise one or more of copper, potassium, iron, manganese, cobalt, palladium, silver, lanthanum, vanadium, chromium, gadolinium, gallium, zinc, nickel, or niobium; adding a nitrogen-containing precipitating reagent to the solution until the solution has a pH of about 6.5; separating solids from the solution to obtain the pre-catalyst; calcining the solids at a temperature between 350° C. and 900° C. to obtain calcined solids; and exposing the calcined solids to CO₂ and H₂ under reaction conditions, to form the catalyst.

B. A pre-catalyst comprising: oxides or carbonates of iron; copper; and potassium; wherein the pre-catalyst comprises 25-100 mol % iron, 30-75 mol % copper, 0.1-10 mol % potassium on a metal basis; and nitrogen.

C. A catalyst comprising: oxides, carbides, carbonates, and metallic particles of iron; oxides and metallic particles of copper; and potassium; wherein the catalyst comprises 25-100 mol % iron, 30-75 mol % copper, 0.1-10 mol % potassium on a metal basis.

D. A method to convert CO₂ to hydrocarbons, comprising: reacting CO₂ and H₂ in the presence of a catalyst of Embodiment C at a reaction temperature, a reaction pressure, and a reaction gas hourly space velocity (GHSV); thereby obtaining hydrocarbons.

Each of embodiments A through D may have one or more of the following additional elements in any combination: Element 1: further comprising reducing the calcined solids under hydrogen gas or mixture of hydrogen and a neutral gas prior to exposing the calcined solids to the CO₂ and H₂ under the reaction conditions. Element 2: wherein the catalyst comprises iron, copper, and potassium. Element 3: wherein the catalyst comprises 25-100 mol % iron, 30-75 mol % copper, 0.1-10 mol % potassium on a metal basis. Element 4: wherein the catalyst comprises 32.8 mol % of Fe, 65.6 mol % of Cu, and 1.6 mol % of K on a total Fe—Cu—K basis. Element 5: wherein the catalyst comprises 0.1-60 mol % metal promoter on a metal basis. Element 6: wherein the metal promoter is selected from the group consisting of manganese, cobalt, palladium, silver, lanthanum, vanadium, chromium, gadolinium, gallium, zinc, nickel, niobium, and combinations thereof. Element 7: wherein the nitrogen-containing precipitating reagent comprises one or more of the group consisting of ammonium carbonate, ammonium lactate, ammonium tartrate, urea, betaine, tetraethylammonium bicarbonate, triethylammonium bicarbonate, and choline bicarbonate. Element 8: wherein the metal salts are nitrates, oxides, citrates, lactates, formates, acetates, sulfates, carbonates, chlorides, bromides, EDTA salts, oxalates, benzoates, stearates, and tartrates. Element 9: wherein calcining is under static air or a flow of 5% to 100% oxygen and 0% to 95% nitrogen. Element 10: wherein the reaction conditions comprise a temperature between 300° C. and 500° C. Element 11: wherein the reduction is for a time from 1 hour to 5 hours. Element 12: wherein the pre-catalyst comprises 32.8 mol % of Fe, 65.6 mol % of Cu, and 1.6 mol % of K on a total Fe—Cu—K basis. Element 13: wherein the pre-catalyst further comprises 0.1-60 mol % metal promoter on a metal basis. Element 14: wherein the pre-catalyst is unsupported. Element 15: wherein the pre-catalyst is free of zeolites. Element 16: wherein the catalyst is unsupported. Element 17: wherein the catalyst is free of zeolites. Element 18: wherein the catalyst is produced by the process of Embodiment A. Element 19: wherein the catalyst is produced by the process of Embodiment A and Element 1. Element 20: wherein the reaction pressure is between 15 bar and 50 bar. Element 21: wherein the reaction temperature is between 300° C. and 500° C. Element 22: wherein the reaction GHSV is between 1000 mL·g⁻¹·h⁻¹ to 100,000 mL·g⁻¹·h⁻¹. Element 23: wherein the yield of C₅₊ hydrocarbons is 25 mol % or greater. Element 24: wherein the selectivity for methane is 6 mol % or less.

By way of non-limiting example, exemplary combinations applicable to one or more of Embodiments A through D include: Element 1 with Element 2; Element 2 with Element 3; Element 3 with Element 4; Element 2 with Element 5; Element 1 with Element 6; Element 7 with Element 8; Element 9 with Element 10; Element 10 with Element 11; Element 12 with Element 13; Element 14 with Element 15; Element 16 with Element 17; Element 20 with Element 21; Element 22 with Element 23; and Element 23 with Element 24.

The terminology used herein is for the purpose of describing particular embodiments only and is not intended to be limiting of the invention. As used herein, for example, the singular forms “a,” “an,” and “the” are intended to include the plural forms as well, unless the context clearly indicates otherwise. It will be further understood that the terms “contains”, “containing”, “includes”, “including,” “comprises”, and/or “comprising,” and variations thereof, when used in this specification, specify the presence of stated features, integers, steps, operations, elements, and/or components, but do not preclude the presence or addition of one or more other features, integers, steps, operations, elements, components, and/or groups thereof.

Terms of orientation used herein are merely for purposes of convention and referencing and are not to be construed as limiting. However, it is recognized these terms could be used with reference to an operator or user. Accordingly, no limitations are implied or to be inferred. In addition, the use of ordinal numbers (e.g., first, second, third, etc.) is for distinction and not counting. For example, the use of “third” does not imply there must be a corresponding “first” or “second.” Also, if used herein, the terms “coupled” or “coupled to” or “connected” or “connected to” or “attached” or “attached to” may indicate establishing either a direct or indirect connection and is not limited to either unless expressly referenced as such.

While the disclosure has described several exemplary embodiments, it will be understood by those skilled in the art that various changes can be made, and equivalents can be substituted for elements thereof, without departing from the spirit and scope of the invention. In addition, many modifications will be appreciated by those skilled in the art to adapt a particular instrument, situation, or material to embodiments of the disclosure without departing from the essential scope thereof. Therefore, it is intended that the invention not be limited to the particular embodiments disclosed, or to the best mode contemplated for carrying out this invention, but that the invention will include all embodiments falling within the scope of the appended claims. Moreover, reference in the appended claims to an apparatus or system or a component of an apparatus or system being adapted to, arranged to, capable of, configured to, enabled to, operable to, or operative to perform a particular function encompasses that apparatus, system, or component, whether or not it or that particular function is activated, turned on, or unlocked, as long as that apparatus, system, or component is so adapted, arranged, capable, configured, enabled, operable, or operative.

The invention claimed is:

1. A method of making a catalyst, comprising:
dissolving one or more metal salts in water to form a solution, wherein the metal salts comprise one or more of copper, potassium, iron, manganese, cobalt, palladium, silver, lanthanum, vanadium, chromium, gadolinium, gallium, zinc, nickel, or niobium;
adding a nitrogen-containing precipitating reagent to the solution until the solution has a pH of about 6.5;
separating solids from the solution to obtain the pre-catalyst;
calcining the solids at a temperature between 350° C. and 900° C. to obtain calcined solids; and
exposing the calcined solids to CO₂ and H₂ under reaction conditions, to form the catalyst.

2. The method of claim 1, further comprising reducing the calcined solids under hydrogen gas or mixture of hydrogen and a neutral gas prior to exposing the calcined solids to the CO₂ and H₂ under the reaction conditions.

3. The method of claim 1, wherein the catalyst comprises iron, copper, and potassium.

4. The method of claim 3, wherein the catalyst comprises 25-100 mol % iron, 30-75 mol % copper, 0.1-10 mol % potassium on a metal basis.

5. The method of claim 3, wherein the catalyst comprises 32.8 mol % of Fe, 65.6 mol % of Cu, and 1.6 mol % of K on a total Fe—Cu—K basis.

6. The method of claim 1, wherein the catalyst comprises 0.1-60 mol % metal promoter on a metal basis.

7. The method of claim 6, wherein the metal promoter is selected from the group consisting of manganese, cobalt, palladium, silver, lanthanum, vanadium, chromium, gadolinium, gallium, zinc, nickel, niobium, and combinations thereof.

8. The method of claim 1, wherein the nitrogen-containing precipitating reagent comprises one or more of the group consisting of ammonium carbonate, ammonium lactate, ammonium tartrate, urea, betaine, tetraethylammonium bicarbonate, triethylammonium bicarbonate, and choline bicarbonate.

9. The method of claim 1, wherein the metal salts are nitrates, oxides, citrates, lactates, formates, acetates, sulfates, carbonates, chlorides, bromides, EDTA salts, oxalates, benzoates, stearates, and tartrates.

10. The method of claim 1, wherein calcining is under static air or a flow of 5% to 100% oxygen and 0% to 95% nitrogen.

11. The method of claim 1, wherein the reaction conditions comprise a temperature between 300° C. and 500° C.

12. The method of claim 2, wherein the reduction is for a time from 1 hour to 5 hours.

13. A pre-catalyst comprising:
oxides or carbonates of iron;
copper; and
potassium;
wherein the pre-catalyst comprises 25-100 mol % iron, 30-75 mol % copper, 0.1-10 mol % potassium on a metal basis; and
nitrogen.

14. The pre-catalyst of claim 13, wherein the pre-catalyst comprises 32.8 mol % of Fe, 65.6 mol % of Cu, and 1.6 mol % of K on a total Fe—Cu—K basis.

15. The pre-catalyst of claim 13, wherein the pre-catalyst further comprises 0.1-60 mol % metal promoter on a metal basis.

16. The pre-catalyst of claim 15, wherein the metal promoter is selected from the group consisting of manganese, cobalt, palladium, silver, lanthanum, vanadium, chromium, gadolinium, gallium, zinc, nickel, niobium, and combinations thereof.

17. The pre-catalyst of claim 13, wherein the pre-catalyst is unsupported.

18. The pre-catalyst of claim 13, wherein the pre-catalyst is free of zeolites.

19. A catalyst comprising:
oxides, carbides, carbonates, and metallic particles of iron;
oxides and metallic particles of copper; and
potassium;
wherein the catalyst comprises 25-100 mol % iron, 30-75 mol % copper, 0.1-10 mol % potassium on a metal basis.

20. The catalyst of claim 19, wherein the catalyst comprises 32.8 mol % of Fe, 65.6 mol % of Cu, and 1.6 mol % of K on a total Fe—Cu—K basis.

21. The catalyst of claim 19, wherein the catalyst further comprises 0.1-60 mol % metal promoter on a metal basis.

22. The catalyst of claim 21, wherein the metal promoter is selected from the group consisting of manganese, cobalt, palladium, silver, lanthanum, vanadium, chromium, gadolinium, gallium, zinc, nickel, niobium, and combinations thereof.

23. The catalyst of claim 19, wherein the catalyst is unsupported.

24. The catalyst of claim 19, wherein the catalyst is free of zeolites.

25. The catalyst of claim 19, produced by the process of claim 1 or claim 2.

26. A method to convert CO₂ to hydrocarbons, comprising:
reacting CO₂ and H₂ in the presence of a catalyst of claim 19 at a reaction temperature, a reaction pressure, and a reaction gas hourly space velocity (GHSV); thereby obtaining hydrocarbons.

27. The method of claim 26, wherein the reaction pressure is between 15 bar and 50 bar.

28. The method of claim 26, wherein the reaction temperature is between 300° C. and 500° C.

29. The method of claim 26, wherein the reaction GHSV is between 1000 mL·g⁻¹·h⁻¹ to 100,000 mL·g⁻¹·h⁻¹.

30. The method of claim 26, wherein the yield of C₅₊ hydrocarbons is 25 mol % or greater.

31. The method of claim 26, wherein the selectivity for methane is 6 mol % or less.
